(19) United States
(12) Patent Application Publication
(10) Pub. No.: US 2025/0069162 A1
(43) Pub. Date: Feb. 27, 2025

(54) MACHINE LEARNING PEST DETECTION

(71) Applicant: GURMAN SINGH GORAYA, Colorado Springs, CO (US)

(72) Inventor: GURMAN SINGH GORAYA, Colorado Springs, CO (US)

(21) Appl. No.: 18/940,799

(22) Filed: Nov. 7, 2024

(51) Int. Cl. G06Q 50/02; G06Q 10/0639

(52) U.S. Cl. CPC G06Q 50/02; G06Q 10/06395

(57) ABSTRACT

Apparatuses, systems, methods, and computer program products for pest detection are described. An apparatus may include a sensor, an electronic display screen, a processor, and/or a memory. A memory may store computer program code executable by a processor to perform operations. An operation may include receiving data detected by a sensor. An operation may include processing data using one or more machine learning models that each determine one or more likelihoods that the data includes evidence of a pest. An operation may include determining whether data includes evidence of a pest based on one or more likelihoods. An operation may include displaying, in response to determining that data includes evidence of a pest, an identifier for the pest on an electronic display screen.

### FIELD

This invention relates to pest detection and more particularly relates to artificial intelligence pest detection.

### BACKGROUND

Pests can cause significant damage to crops, affecting food security as well as having severe economic impacts. Pests can be unpredictable and difficult to detect, or detection techniques can be subjective and time consuming.

### SUMMARY

Apparatuses for pest detection are presented. In one embodiment, an apparatus includes a sensor, an electronic display screen, a processor, and/or a memory. A memory, in certain embodiments, stores computer program code executable by a processor to perform operations. In some embodiments, an operation includes receiving data detected by a sensor. An operation, in a further embodiment, includes processing data using one or more machine learning models that each determine one or more likelihoods that the data includes evidence of a pest. An operation, in another embodiment, includes determining whether data includes evidence of a pest based on one or more likelihoods. In some embodiments, an operation includes displaying, in response to determining that data includes evidence of a pest, an identifier for the pest on an electronic display screen.

Computer program products for pest detection are presented. A computer program product, in some embodiments, includes a non-transitory computer readable storage medium storing computer program code executable to perform operations. In some embodiments, an operation includes receiving an image detected by an image sensor. An operation, in a further embodiment, includes processing an image using one or more machine learning models that each determine one or more likelihoods that an image includes evidence of a pest. An operation, in another embodiment, includes determining whether an image includes evidence of a pest based on one or more likelihoods. In some embodiments, an operation includes displaying, in response to determining that an image includes evidence of a pest, an identifier for the pest on an electronic display screen.

Methods for pest detection are presented. In some embodiments, a method includes receiving data detected by a sensor. A method, in a further embodiment, includes processing data using one or more machine learning models that each determine one or more likelihoods that data includes evidence of a pest. A method, in another embodiment, includes determining whether data includes evidence of a pest based on one or more likelihoods. In some embodiments, an operation includes displaying, in response to determining that data includes evidence of a pest, an identifier for the pest on an electronic display screen.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a system for pest detection;

FIG. 2 is a schematic block diagram illustrating a further embodiment of a system for pest detection;

FIG. 3 is a schematic flow chart diagram illustrating one embodiment of a method for pest detection; and

FIG. 4 is a schematic flow chart diagram illustrating a further embodiment of a method for pest detection.

### DETAILED DESCRIPTION

Aspects of the present invention are described herein with reference to system diagrams, flowchart illustrations, and/or block diagrams of methods, apparatuses, systems, and computer program products according to embodiments of the invention. It will be understood that blocks of the flowchart illustrations and/or block diagrams, and combinations of blocks in the flowchart illustrations and/or block diagrams, can be implemented by computer readable program instructions.

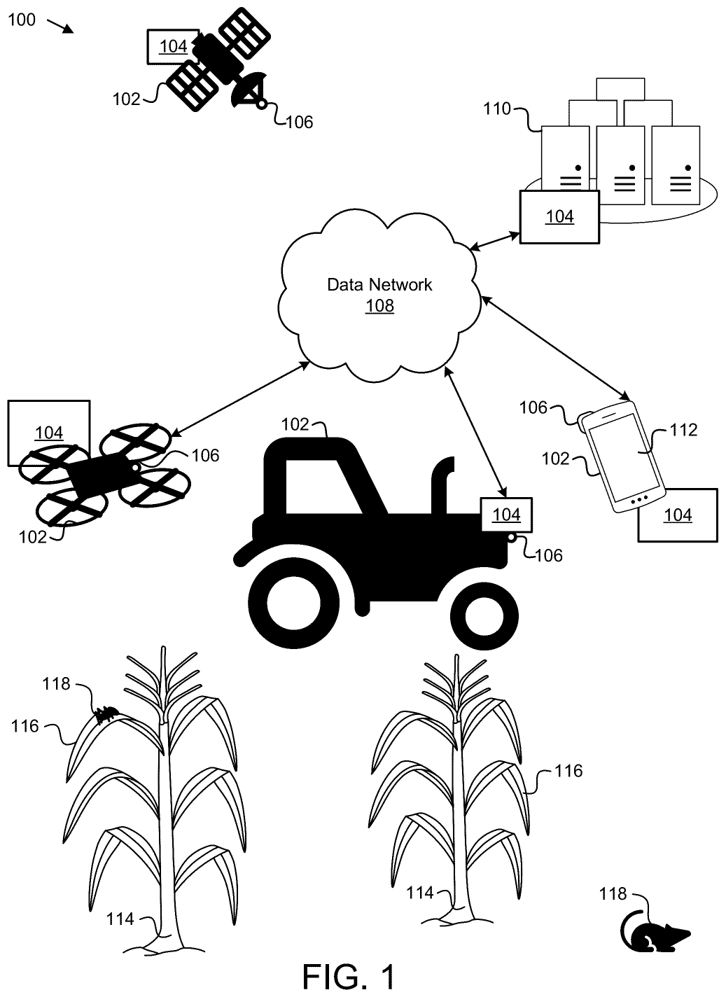

FIG. 1 depicts one embodiment of a system 100 for pest detection. The system 100, in the depicted embodiment, includes one or more hardware computing devices 102 and/or vehicles 102 (e.g., a mobile computing device 102, a laptop and/or desktop computing device 102, an unmanned aircraft 102, a satellite 102, farming equipment 102 such as a tractor 102, or the like), one or more pest detection modules 104, one or more sensors 106, a data network 108, one or more server computing devices 110, one or more electronic display screens 112, one or more plants 114 (e.g., crops 114 with leaves 116, or the like), and one or more pests 118 and/or evidence of one or more pests 118.

In general, a pest detection module 104 is configured to determine one or more likelihoods that data from a sensor 106 includes evidence of a pest 118 (e.g., an insect, a rodent, a fungus, a disease, a bacteria, a virus, and/or another agent that damages and/or negatively effects a crop 114). A pest detection module 104 may determine whether the data includes evidence of a pest 118 based on the one or more likelihoods (e.g., based at least partially on an image, video, and/or other data from a camera 106 and/or other image sensor 106; based at least partially on an audio recording from a microphone 106 and/or other audio sensor 106; or the like).

In this manner, in certain embodiments, a system 100 may detect and/or report one or more pests 118 using artificial intelligence and/or other machine learning, thereby enabling automated and/or early detection of pest 118, reducing an amount of pesticides used (e.g., due to the early detection), notification of other users in a migration path of a pest 118, notification of one or more other users associated with a same geographic region as a sensor 106, or the like. For example, in certain embodiments, a pest detection module 104 may process an image and/or video of crops 116 (e.g., one or more plants 114, farmland 114, or the like) and may determine whether there is a pest 118, evidence of a pest 118, or the like.

A pest detection module 104, in some embodiments, may use artificial intelligence and/or other machine learning to process one or more images, video, audio, and/or other data from a sensor 106. A pest detection module 104 may process data from a sensor 106 using multiple machine learning models, to determine one or more likelihoods that the data includes evidence of one or more pests 118 (e.g., evidence such as images including one or more pests 118, bit marks of a pest 118, scat and/or droppings of a pest 118, crop 116 damage from a pest 118, and/or other signs of a pest 118). A pest detection module 104 may determine whether data includes evidence of a pest 118 based on a combination of multiple likelihoods from multiple machine learning models, or the like.

A pest detection module 104 may be configured to perform a predefined action based on a pest 118 detection, such as providing a user interface and/or other notification to a user (e.g., a graphical user interface (GUI), an application programming interface (API), a push notification, a text message, an email, or the like), displaying an identifier for a pest 118, determining and/or displaying an action to mitigate one or more effects of a pest 118, applying a treatment to a plant 114 and/or leaf 116 targeting a pest 118 or its effects, quarantining a plant 114 and/or leaf 116, destroying a plant 114/leaf 116/pest 118, or the like based on a pest 118 recognition.

For example, in some embodiments, a pest detection module 104 may comprise and/or be in communication with computer program code installed and/or executing on a hardware computing device 102, or the like such as a mobile application, a desktop application, a server application, or other computer program code executable by a processor and may display a user interface and/or perform a different action on an electronic display screen 112 of and/or using other hardware of the hardware computing device 102; may be disposed on and/or in communication with an unmanned aircraft 102 (e.g., a drone 102), a robot 102, farming equipment 102 such as a tractor 102, and/or other manned or unmanned vehicle comprising a store of treatment, an herbicide or other pesticide, and/or a dispenser to apply a treatment and/or pesticide; or the like. A pest detection module 104 may be configured to perform different actions for different types of pests 118.

A pest detection module 104, in some embodiments, may support multiple sources and/or input methods for data from a sensor 106. In one embodiment, a pest detection module 104 may receive data from a hardware computing device 102 and/or a sensor 106 over a wireless and/or wired data network 108, such as a wireless Bluetooth® connection, a wireless Wi-Fi connection, a wired ethernet connection, a wired universal serial bus (USB) connection, or the like.

In certain embodiments, a pest detection module 104 may receive an uploaded image from a sensor 106 (e.g., which a user may upload from a hardware computing device 102 and/or another source uploaded to a server computing device 110 over a data network 108, or the like) through a user interface (e.g., a GUI such as an application executing on a hardware computing device 102 and/or a web interface over a data network 108, an API, a command line interface (CLI), or the like).

A pest detection module 104, in one embodiment, determines a likelihood that data includes evidence of a pest 118 based at least partially on data from a camera 106 or other sensor 106 and/or a hardware computing device 102. A likelihood that a plant 114, a leaf 116, and/or other crop 114 has a pest 118, and/or that data includes evidence of a pest 118, as used herein, comprises an estimated and/or predicted indication of whether data indicates the presence of a pest 118 (e.g., a confidence metric, a percentage likelihood, low/medium/high, green/yellow/red, an actual and/or estimated likelihood, or the like).

A pest detection module 104 may process and/or analyze data from a sensor 106 and/or a hardware computing device 102 to determine a likelihood of one or more pests 118, a likelihood of evidence of one or more pests, or the like. In some embodiments, a pest detection module 104 may provide data from one or more sensors 106 and/or hardware computing devices 102 as inputs into one or more machine learning models and/or other artificial intelligence and may receive one or more likelihoods of a pest 118 and/or of evidence of a pest 118 as an output. In a further embodiment, a pest detection module 104 may use one or more machine learning models to predict a potential crop yield (e.g., based on data from a sensor 106; based on identifiers for one or more detected pests 118; based on supplemental data such as soil composition, weather patterns, and/or historical crop yields; or the like) and may display a predicted crop yield to a user on an electronic display screen 112. In this manner, in certain embodiments, a user may more intelligently estimate a profit margin, select which crops 114 to plant and/or in what rotation to plant crops 114, or the like based on predicted crop yields.

A pest detection module 104, in one embodiment, may be configured to perform a predefined action based on a likelihood of a pest 118 and/or of evidence of a pest 118 (e.g., in response to the likelihood satisfying a threshold, based on a level of the likelihood, based on a type of pest 118, based on a number of pests 118, or the like). A pest detection module 104, in some embodiments, may perform an action comprising notifying a user (e.g., using an electronic display screen 112 of a hardware computing device 102, using an electronic speaker of a hardware computing device 102, or the like).

For example, a pest detection module 104 may perform an action notifying a user of which pests 118 the pest detection module 104 has detected evidence, of whether a crop 114 is healthy, of an action to mitigate one or more effects of a pest 118, or the like. A pest detection module 104 may determine and/or display an action to mitigate one or more effects of a pest 118 (e.g., relative to one or more crops 114 or the like) such as a type of pesticide for treating a pest 118, a timing for harvesting a crop 114 associated with a pest 118, a predator of a pest 118 to introduce (e.g., a fish, a dog, a cat, a type of insect, or the like), a deterrent to introduce for a pest 118 (e.g., a scarecrow, a scent, or the like), a type of light to introduce for a pest 118, an irrigation time, an irrigation amount, or the like to mitigate one or more effects of a pest 118.

For example, in a GUI on an electronic display screen 112 of a hardware computing device 102, a pest detection module 104 may display a most recent likelihood of a pest 118, a health status of a crop 114, or the like; may display a graph, one or more trends, and/or another history of previous likelihoods of a pest 118, or the like (e.g., in an interactive GUI which a user may select starting and/or ending dates, zoom into different time periods, select different data elements, or the like); may display one or more recommendations, actions, and/or other notifications; and/or other user interface elements based on a likelihood of a pest 118 and/or of evidence of a pest 118. A pest detection module 104, in other embodiments, may display one or more metrics for a hardware computing device 102, such as a battery level, a device identifier, one or more settings, or the like.

In some embodiments, a pest detection module 104 may be configured to track one or more pests 118 in an environment (e.g., in and/or around a sensor 106, a field, a farm, a city, a town, a county, a state, a country, another geographic location, or the like). For example, a pest detection module 104 may determine a direction, vector, speed, or the like for a pest 118; may track pest 118 locations and/or spread to determine a migration path for the pests 118; may determine a likelihood of a pest 118 based on both data from a sensor 106 and location data of previously identified instances of a pest 118; may notify one or more other users in a path of a migration pattern of a pest 118; may notify one or more other users in a geographic region; or the like.

In certain embodiments, a pest detection module 104 may communicate with one or more location sensors in order to track locations and/or spread of a pest 118, such as a global positioning system (GPS) sensor of a hardware computing device 102, a sensor 106 such as a camera that has detected a presence of a pest 118, one or more cell towers and/or wireless routers (e.g., to determine a location of a hardware computing device 102 and/or sensor 106 using triangulation), or the like. A pest detection module 104 may determine a recommended action for a user based on a location of one or more tracked pests 118, may notify one or more users in a path of a migration pattern of a pest 118, may display a location of a pest 118 and/or a migration path of a pest 118 on a map, or the like. Multiple pest detection modules 104, in some embodiments, may communicate with each other over a data network 108 to share identifiers of detected pests 118, predicted migration patterns of pests 118, or the like with other users in a community and/or other geographic region (e.g., in a peer-to-peer manner, through a centralized backend server 110, or the like).

A hardware computing device 102, in some embodiments, comprises a mobile computing device 102 (e.g., a cellular telephone or other mobile telephone, a tablet device, a laptop computer, a portable pest detection device, a handheld device, or the like) that may comprise a sensor 106, an electronic display screen 112, a processor, a memory (e.g., volatile and/or non-volatile). A pest detection module 104 may comprise a mobile application and/or other executable computer program code executing on the mobile computing device 102.

In a further embodiment, a hardware computing device 102 comprises an unmanned aircraft 102 (e.g., a drone, or the like) that comprises a sensor 106 and that flies in proximity to a crop 114 to take one or more images of potential pests 118, or the like. A hardware computing device 102, in certain embodiments, comprises and/or is installed on a vehicle 102, such as tractor 102 or other farming equipment 102 driving in proximity to a crop 114 to detect evidence of a pest 118, or the like. In one embodiment, a hardware computing device 102 comprises and/or is installed on a satellite 102 comprising a sensor 106 to detect one or more pests 118 within a range of the sensor 106 from orbit. In some embodiments, a pest detection module 104 may execute on and/or be in communication with a backend server computing device 110.

In some embodiments, a pest detection module 104 may comprise logic hardware such as one or more of a processor (e.g., a CPU, a controller, a microcontroller, firmware, microcode, an application specific integrated circuit (ASIC), a field programmable gate array (FPGA) or other programmable logic, or the like), a volatile memory, a non-volatile computer readable storage medium, a network interface, a printed circuit board, or the like. A pest detection module 104, in further embodiments, may include computer program code stored on a non-transitory computer readable storage medium (e.g., of a hardware computing device 102 and/or of a hardware computing device 102), executable by a processor to perform one or more of the operations described herein, or the like.

A pest detection module 104, in certain embodiments, may receive user input from a hardware computing device 102 (e.g., from a button, switch, touchscreen, and/or other user interface element), from a remote control device (e.g., an infrared remote control, a radio frequency remote control, a Bluetooth® remote control, or the like), from a user interface of a hardware computing device 102 over a data network 108 (e.g., a mobile computing device such as a smartphone, a smart watch, a tablet, a laptop, or the like; a desktop computer; a gaming device; a set-top box; a point-of-sale device, and/or another hardware computing device 102 comprising a processor and a memory).

The data network 108, in one embodiment, includes a digital communication network that transmits digital communications. The data network 108 may include a wireless network, such as a wireless cellular network, a local wireless network, such as a Wi-Fi network, a Bluetooth® network, a near-field communication (NFC) network, an ad hoc network, or the like. The data network 108 may include a wide area network (WAN), a local area network (LAN), an optical fiber network, the internet, or other digital communication network. The data network 108 may include a combination of two or more networks. The data network 108 may include one or more servers, routers, switches, and/or other networking equipment.

One or more pest detection modules 104, hardware computing devices 102, electronic display screens 112, and/or hardware computing devices 102 may be in communication over a data network 108, either directly or through a backend server computing device 110, or the like. A pest detection module 104 executing on a hardware computing device 102 (e.g., computer executable program code, an installable application, a mobile application, or the like), in some embodiments, may provide a user interface to notify a user and/or for a user to perform one or more actions and/or selections described herein.

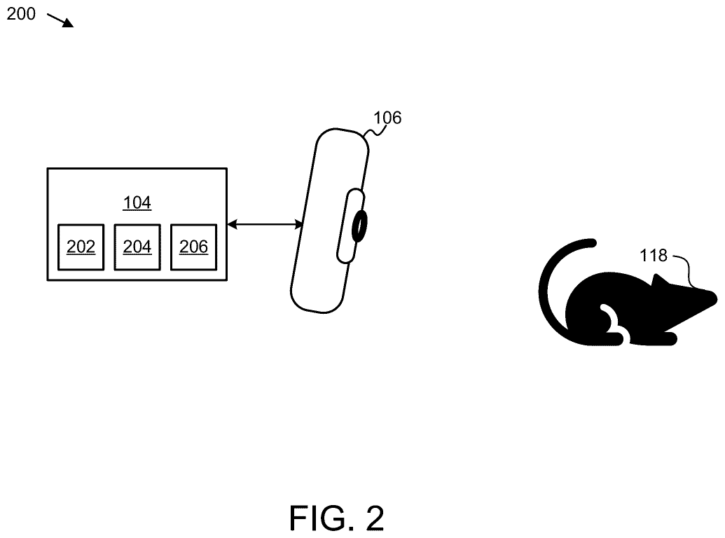

FIG. 2 depicts one embodiment of a system 200 for pest detection. The system 200 of FIG. 2, in some embodiments, may be substantially similar to the system 100 described above with regard to FIG. 1. In the depicted embodiment, the pest detection module 104 includes one or more machine learning models 202, 204, 206 such as a mobile convolutional neural network 202, a residual convolutional neural network 204, a deep convolutional neural network 206, or the like.

A sensor 106, in one embodiment, may comprise a camera 106 integrated with and/or in communication with a hardware computing device 102 (e.g., a smartphone 102 camera 106, a webcam 106, a drone 102 camera 106, a sensor 106 of a dedicated application-specific hardware pest detection device 104, or the like). In a further embodiment, a sensor 106 may comprise a dedicated camera device 106 installed in view of a crop 114, or the like (e.g., a security camera 106, a network camera 106, a USB camera 106, a trail camera 106, a field camera 106, or the like). In some embodiments, a pest detection module 104 may be configured to receive image data (e.g., one or more photos and/or videos) directly from a sensor 106. In other embodiments, a pest detection module 104 may provide a GUI allowing a user to upload image data (e.g., one or more photos and/or videos) from a sensor 106 to the pest detection module 104 over a data network 108, or the like.

A sensor 106 may capture image data (e.g., one or more photos and/or videos, or the like) of one or more plants 114, a field of crops 114, a habitat of a pest 118, or the like. A pest detection module 104, in some embodiments, may process the image data (e.g., one or more photos and/or videos from a camera 106 or other sensor 106) to recognize one or more pests 118. For example, a pest detection module 104 may use one or more machine learning models 202, 204, 206 and/or other artificial intelligence image recognition to recognize a pest 118 (e.g., determine a likelihood that data from a sensor 106 includes evidence of a pest 118, or the like).

A pest detection module 104, in certain embodiments, uses deep learning and/or other artificial intelligence to detect one or more pests 118, for early detection, or the like (e.g., in an automated manner, before the pest 118 is detectable to the human eye, or the like). In a further embodiment, a pest detection module 104 may use a transfer learning technique for image classification with a convolutional neural network (CNN) based model 202, 204, 206, or the like. A CNN-based machine learning model 202, 204, 206 may comprise a series of layers, each of which includes a set of filters that are applied to an input image and/or other data. Filters may be used to detect specific patterns and/or features in an image, and the output of each layer may be passed on to the next layer for further processing until a likelihood of a pest 118 being present, an identity of a pest 118, a recommended action for a pest 118, a migration path for a pest 118, or the like is output.

In one embodiment, a pest detection module 104 may use multiple machine learning models 202, 204, 206 (e.g., two models, three models, four models, more than four models, or the like) in combination, such as a machine learning ensemble comprising multiple machine learning models 202, 204, 206 (e.g., to optimize pest detection and/or performance). For example, in some embodiments, at least one of the multiple machine learning models 202, 204, 206 comprise a convolutional neural network. In a further embodiment, the multiple machine learning models 202, 204, 206 comprise multiple convolutional neural networks.

For example, in one embodiment, a pest detection module 104 may use a mobile convolutional neural network 202 (e.g., with memory, storage, and/or processing requirements configured to execute on an embedded system 102, for on-device image classification, mobile vision, or the like) that uses depth wise separable convolutions applying a single filter to each input channel and performing a one-by-one pointwise convolution to combine the results across all of the input channels to determine a likelihood of a pest 118. A mobile convolutional neural network 202 may use an expansion layer to decompress input data for a depth-wise convolution layer (e.g., used to reduce a number of parameters) that filters the data for a projection layer that compresses the data for output, or the like. In a further embodiment, a mobile convolutional neural network 202 may include a squeeze layer, an excitation layer, or the like (e.g., in a residual layer). A mobile convolutional neural network 202 may use h-swish non-linearity, may give unequal weights to different input channels when creating output feature maps, or the like. A mobile convolutional neural network 202 may be based on an inverted residual structure where the input and output of the residual block are thin bottleneck layers opposite residual models which use expanded representations at the input. A mobile convolutional neural network 202 may use lightweight depth wise convolutions to filter features in an intermediate expansion layer.

A pest detection module 104, in some embodiments, uses a residual convolutional neural network 204 with multiple stacked nonlinear layers and an identity mapping to determine a likelihood of pest 118. For example, a residual convolutional neural network 204 may include a plurality of residual blocks with skip connections configured to connect activations of a layer to another layer by skipping one or more layers in between to form a residual block. In this manner, instead of layers learning an underlying mapping, the network is fit to the residual mapping (e.g., using skip connections, residual blocks, or the like).

A pest detection module 104, in one embodiment, uses a deep convolutional neural network 206 with a plurality of fully connected layers and a plurality of convolutional layers (e.g., 16 layers, convolutional filters, hidden layers, pooling layers, fully connected layers, or the like) each with a three-by-three receptive field with a one pixel stride to determine a likelihood of a pest 118. For example, by using a plurality of smaller three-by-three receptive fields, they combined provide the function of a larger receptive field but more non-linear activation layers accompany the convolution layers, improving decision functions and allowing the deep convolutional neural network 206 to converge more quickly, or the like. Using a smaller convolutional filter (e.g., a three-by-three filter, or the like) may reduce a tendency to over-fit during training, but may still capture left-right and up-down information to allow for an image's spatial features.

To train the machine learning models 202, 204, 206, a pest detection module 104 may use a large dataset of input-output pairs (e.g., labeled images of crops 114 and/or pests 118) and may use an optimization algorithm to adjust weights and/or biases of the network (e.g., the machine learning model 202, 204, 206 being trained) such that it can accurately predict the labels (e.g., likelihoods of pests 118) of new images.

A pest detection module 104 may use a machine learning model 202, 204, 206 trained initially using a transfer learning technique for image classification (e.g., a model that has been trained on one task may be re-purposed and/or fine-tuned for use identifying one or more pests 118). For image classification, a pest detection module 104 may use transfer learning with a pre-trained image classification model (e.g., pre-trained on images of objects other than pests 118, or the like) as a starting point for training a new model on a pest 118 dataset (e.g., images of crops 114 having a plurality of pests 118, or the like).

The pre-trained model may be a large and/or complex model that has been trained on a very large dataset, which contains millions of images with thousands of different classes, or the like. To transfer the knowledge from the pre-trained model to the new model, a pest detection module 104 may freeze the weights of the pre-trained model and train the new model using a new dataset of crops 114 and/or pests 118. Transfer learning may allow a new model to take advantage of the feature extraction capabilities of a pre-trained model, while still being able to learn task-specific features from a new dataset, or the like.

The machine learning models 202, 204, 206, in some embodiments, may include one or more added layers, such as a pooling average layer, one or more dens layers (e.g., with 100 units, with a rectified linear unit activation function, with a softmax activation function, or the like). A pest detection module 104 may determine whether a crop 114 has a pest 118 based on one or more likelihoods from multiple machine learning models 202, 204, 206. For example, the pest detection module 104 may arrange multiple machine learning models 202, 204, 206 into a voting ensemble (e.g., determining that a crop 114 has a pest 118 if likelihoods from a majority vote of the models 202, 204, 206 indicate by at least a threshold likelihood that the crop 114 has the pest 118), may determine that a crop 114 has a pest 118 if likelihoods from at least one of the models 202, 204, 206 indicate that the crop 114 has a pest 118 by at least a threshold likelihood (e.g., a less conservative approach), may determine that a crop 114 has a pest 118 if likelihoods from each one of the models 202, 204, 206 indicate that the crop 114 has a pest 118 by at least a threshold likelihood (e.g., a more conservative approach), and/or may otherwise combine likelihoods from multiple machine learning models 202, 204, 206 to determine whether a crop 114 has a pest 118.

A pest detection module 104, in some embodiments, may perform one or more processing steps on an image from a sensor 106 (e.g., to format the image for multiple machine learning models 202, 204, 206, or the like). For example, a pest detection module 104 may crop and/or resize an image of a leaf 116 and/or plant 114 to a predefined size for at least one of the multiple machine learning models 202, 204, 206 (e.g., standardizing an image, or the like).

A pest detection module 104, in one embodiment, is configured to display, in response to determining that a crop 114 has one or more of a plurality of pests 118, one or more identifiers for the one or more pests 118 to a user on an electronic display screen 112 (e.g., of a hardware computing device 102, or the like). In a further embodiment, a pest detection module 104 is configured to display, in response to determining that a crop 114 has none of a plurality of pests 118, an indication that the crop 114 is healthy and/or free of pests 118 to a user on an electronic display screen 112.

In some embodiments, a pest detection module 104 may comprise computer program code stored in a memory and executable by a processor to perform one or more of the operations described herein with regard to a pest detection module 104. For example, a processor may comprise a CPU, a microcontroller, firmware, microcode, an ASIC, an FPGA or other programmable logic, or the like (e.g., of a hardware computing device 102, of a server 110, of an unmanned aircraft 102 or other vehicle 102, or the like), and a memory may comprise a volatile memory, a non-transitory computer readable storage medium, or the like in communication with a processor.

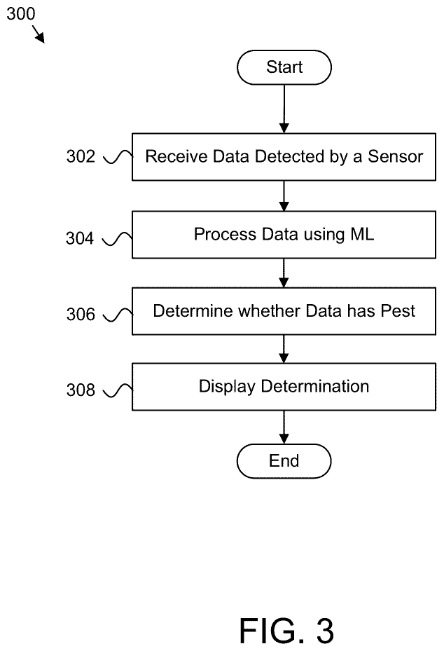

FIG. 3 depicts one embodiment of a method 300 for pest detection. The method 300 begins and a pest detection module 104 receives 302 data detected by a sensor 106. A pest detection module 104 processes 304 the data using one or more machine learning models 202, 204, 206, each of the one or more machine learning models determining one or more likelihoods that the data includes evidence of a pest 118.

A pest detection module 104 determines 306 whether the data includes evidence of the pest 118 based on the one or more likelihoods. A pest detection module 104 displays 308, in response to determining that the data includes evidence of the pest 118, an identifier for the pest 118 on an electronic display screen 112 of a hardware computing device 102 and the method 300 ends.

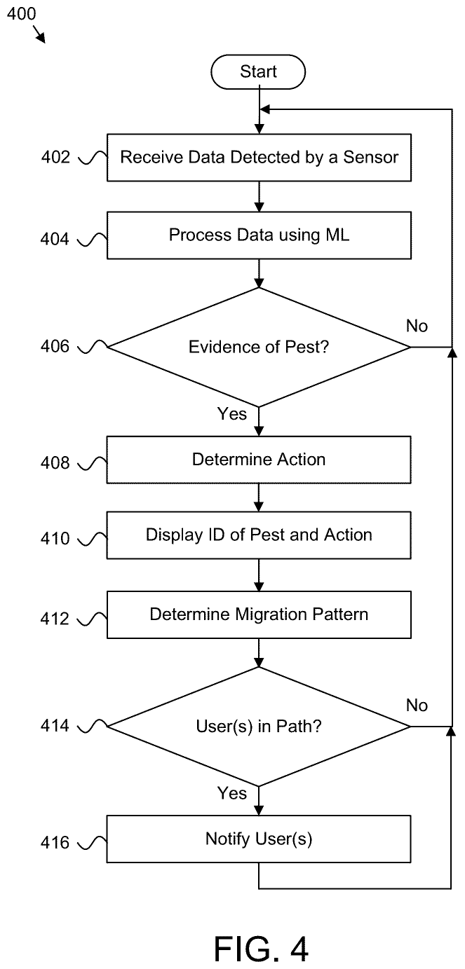

FIG. 4 depicts one embodiment of a method 400 for pest detection. The method 400 begins and a pest detection module 104 receives 402 data detected by a sensor 106. A pest detection module 104 processes 404 the data using one or more machine learning models 202, 204, 206, each of the one or more machine learning models determining one or more likelihoods that the data includes evidence of a pest 118. If a pest detection module 104 determines 406 that the data does not include evidence of a pest 118, the method 400 continues to receive 402 and process 404 subsequent data from a sensor 106.

In response to a pest detection module 104 determining 406 that the data does include evidence of a pest 118, a pest detection module 104 determines 408 an action to mitigate one or more effects associated with the pest 118 and a pest detection module 104 displays 410 an identifier for the pest 118 and/or the determined 408 action on an electronic display screen 112 of a hardware computing device 102.

A pest detection module 104 processes data from one or more additional sensors 106 and the data from the sensor 106 to determine 412 a migration pattern for the pest 118. In response to a pest detection module 104 determining 414 that one or more users are in and/or near a path of the determined 412 migration pattern, a pest detection module 104 notifies 416 the one or more users of the determined 412 migration pattern, an identifier for the pest 118, or the like and the method 400 continues.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer or service or entirely on the remote computer or server or set of servers. In the latter scenario, the remote computer may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a network interface, a controller (e.g., a CPU, a processor core, an FPGA or other programmable logic, an ASIC, a microcontroller, and/or another semiconductor integrated circuit device), a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a sensor;
an electronic display screen;
a processor; and
a memory storing computer program code executable by the processor to perform operations, the operations comprising:
receiving data detected by the sensor;
processing the data using one or more machine learning models, each of the one or more machine learning models determining one or more likelihoods that the data includes evidence of a pest;
determining whether the data includes the evidence of the pest based on the one or more likelihoods; and
displaying, in response to determining that the data includes the evidence of the pest, an identifier for the pest on the electronic display screen.

2. The apparatus of claim 1, the operations further comprising:
determining an action to mitigate one or more effects of the pest; and
displaying the action on the electronic display screen.

3. The apparatus of claim 2, wherein the action is determined using one or more additional machine learning models.

4. The apparatus of claim 2, wherein the action is relative to one or more crops associated with the data.

5. The apparatus of claim 2, wherein the action comprises one or more of a type of pesticide for treating the pest, a timing for harvesting a crop associated with the pest, a predator of the pest to introduce, a deterrent to introduce for the pest, a type of light to introduce for the pest, an irrigation time, and an irrigation amount.

6. The apparatus of claim 1, wherein the pest comprises an insect.

7. The apparatus of claim 1, further comprising a mobile computing device, wherein the mobile computing device comprises the sensor, the electronic display screen, the processor, and the memory, and the computer program code comprises a mobile application executing on the mobile computing device.

8. The apparatus of claim 1, wherein receiving the data comprises receiving, at a hardware server device over a data network, an upload of the data, the hardware server device comprising the processor and the memory.

9. The apparatus of claim 1, further comprising a satellite in orbit, the satellite comprising the sensor, the pest being within a range of the sensor from orbit.

10. The apparatus of claim 1, further comprising a vehicle, the vehicle comprising the sensor.

11. The apparatus of claim 10, wherein the vehicle comprises an unmanned aircraft flying in proximity to the pest to capture the data.

12. The apparatus of claim 10, wherein the vehicle comprises farming equipment driving in proximity to a crop to detect evidence of the pest.

13. The apparatus of claim 12, wherein the farming equipment comprises a tractor.

14. The apparatus of claim 1, wherein the sensor comprises an image sensor and the data comprises one or more of image data and video data.

15. The apparatus of claim 1, wherein the sensor comprises an audio sensor and the data comprises an audio recording.

16. The apparatus of claim 1, further comprising one or more additional sensors, the operations further comprising:
processing data from the one or more additional sensors and the data from the sensor to determine a migration pattern for the pest; and
notifying one or more users in a path of the migration pattern of the pest.

17. The apparatus of claim 1, the operations further comprising notifying one or more other users of the identifier for the pest, the one or more other users associated with a geographic area of the sensor.

18. The apparatus of claim 1, the operations further comprising:
predicting a crop yield based on the data detected by the sensor and on the identifier for the pest; and
displaying the predicted crop yield on the electronic display screen.

19. A computer program product comprising a non-transitory computer readable storage medium storing computer program code executable to perform operations, the operations comprising:
receiving an image from an image sensor;
processing the image using one or more machine learning models, each of the one or more machine learning models determining one or more likelihoods that the image includes evidence of a pest;
determining whether the image includes the evidence of the pest based on the one or more likelihoods; and
displaying, in response to determining that the image includes the evidence of the pest, an identifier for the pest on an electronic display screen.

20. A method comprising:
receiving data detected by a sensor;
processing the data using one or more machine learning models, each of the one or more machine learning models determining one or more likelihoods that the data includes evidence of a pest;
determining whether the data includes the evidence of the pest based on the one or more likelihoods; and
displaying, in response to determining that the data includes the evidence of the pest, an identifier for the pest on an electronic display screen.
